(19) United States
(12) Patent Application Publication
(10) Pub. No.: US 2008/0152759 A1
(43) Pub. Date: Jun. 26, 2008

(54) Fresh Dairy Products with Improved Microbial Stability

(76) Inventors: Yeong-Ching Albert Hong, Kildeer, IL (US); Zuoxing Zheng, Palatine, IL (US); Jimbay P. Loh, Green Oaks, IL (US); Richard Lincourt, Mundelein, IL (US)

Correspondence Address: FITCH EVEN TABIN & FLANNERY, 120 S. LASALLE STREET, SUITE 1600, CHICAGO, IL, 60603-3406, US

(21) Appl. No.: 11/615,487

(22) Filed: Dec. 22, 2006

(51) Int. Cl. A23C 9/12

(52) U.S. Cl. 426/39; 426/43

(57) ABSTRACT

Highly antimicrobial dairy products, and especially highly antimicrobial fresh cheese products, that are resistant to growth of both Gram positive and Gram negative pathogens are provided. Remarkably, these products are resistant to all five major pathogens that commonly present contamination problems in fresh cheese. The products are prepared by acidifying a dairy product to a pH of 4.5 to 6.1 with an inorganic acidulant and then incorporating an antimicrobial composition containing a bacteriocin and an antimicrobial organic acid. Methods of retaining desired functional characteristics in such antimicrobial dairy products are also provided.

### FIELD OF THE INVENTION

This invention relates to dairy products, particularly fresh cheeses that have normal functional and organoleptic properties but increased resistance to microbial growth, particularly pathogenic microbial growth. Products manufactured according to the present invention may be stored under refrigerated conditions with significantly reduced risk of pathogenic growth for longer periods of time than otherwise possible.

### BACKGROUND OF THE INVENTION

Consumers in the United States have traditionally been able to obtain a variety of natural and processed cheeses for any number of uses, and the variety of cheeses available is always increasing. In recent years the demand for “ethnic” cheeses, and other cheeses traditionally thought of as “specialty” cheeses, has experienced a particularly dramatic increase. These cheeses include a variety of high pH and high moisture dairy compositions and a variety of fresh, unripened cheeses. The term “fresh cheese” or “unripened cheese” refers to cheeses that are manufactured with little or no culturing and/or coagulation with enzymes. Fresh cheeses are especially popular in Hispanic dishes, and there are many Mexican or Hispanic style fresh cheeses such as Panela, Ranchero, Cuajada, Quesito, Adabra, De Mano, Queso Blanco, and Queso Fresco. These cheeses were originally made with raw (unpasteurized) milk, but due to health concerns the FDA now requires pasteurization of all milk used in the manufacture of fresh cheese. However, fresh cheeses do not receive any further heat treatment sufficient to destroy and/or inactivate most microorganisms, including pathogens.

Queso Fresco, one type of fresh cheese commonly used in Mexican dishes, is made by adding an enzyme, typically rennet, without culture to whole or part-skim pasteurized milk. The rennet coagulates the milk rapidly, and the resulting curds are cooked in order to firm them. The curds are drained and salted, and then milled into small pieces and placed into molds. Queso Fresco is a white, mild-tasting, somewhat salty cheese with a texture that is firm enough to slice but that crumbles easily. It has a characteristically high pH when compared to many other cheeses. It is often sprinkled atop Mexican dishes, such as tamales, tacos, quesadillas, enchiladas, beans and bean dishes, and soups. Queso Fresco is referred to as a “melt restricted” cheese because it does not melt, although it does soften upon heating.

Commercial Queso Fresco is usually made without an acid-developing culture and normally has a pH of about 6.4. The high pH of Queso Fresco cheese (as well as similar high pH unripened cheeses) is ordinarily required in order to retain desired functional properties (such as melt restriction and the ability to be sliced and/or crumbled) and organoleptic properties (such as color, taste, and mouth-feel).

Unfortunately, fresh cheeses are also common targets for contamination. Many refrigerated, fresh food products in general are prone to post-processing contamination and have resulted in many outbreaks of food poisoning. Cheeses such as Queso Fresco are particularly susceptible to contamination due to their relatively high pH and the fact that the heat treatments involved in their production are generally less rigorous than those of other types of cheese. Indeed, regulatory agencies have issued general warnings that pregnant women, immuno-compromised patients, and very young infants with still developing immune systems should not consume such unripened cheese.

Pasteurization of the milk used in the manufacture of such cheeses has reduced, but not eliminated, concerns of bacterial contamination in fresh cheeses. Pasteurization generally kills pathogens that are present in the starting milk substrate. However, this does not alleviate concerns regarding post-processing contamination, such as improper handling or storage by the manufacturer or the consumer. Once a portion of cheese is contaminated, pathogens can rapidly grow to unsafe levels throughout the cheese, since the high pH environment offered by fresh cheese is well-suited for bacterial growth.

Although great advances have been made in food production, packaging, and storage that have enhanced food safety and reduced or eliminated a number of contamination concerns, contamination of fresh cheeses and cheese compositions by both Gram-positive and Gram-negative pathogens has remained a problem. The five pathogens that are of particular concern in the manufacture and distribution of fresh cheese are: Clostridium botulinum, Listeria monocytogenes, Staphylococcus aureus, Escherichia coli, and Salmonella species. These pathogens are known to be especially likely to contaminate fresh cheeses, and outbreaks of each organism persist despite advances in processing and packaging. A number of other pathogens are also of concern, but not to the extent of the five organisms named above.

Listeria monocytogenes is a very hardy organism which can grow in the presence of other culture organisms and is resistant to many antibiotics. It can grow in cheese brine containing 6% salt and can survive over wide pH ranges and temperatures. In general, L. monocytogenes prefers temperatures between 30 and 47° C., but can grow in the range 1 to 45° C. The optimum pH range for L. monocytogenes is about 6.0 to about 8.0. Although L. monocytogenes prefers to grow at these optimal ranges, it can grow at pH 5 to 10. In fact, more recent studies have shown that L. monocytogenes may survive and grow at pH values as low as 4.4. Unfortunately, the pH of Queso Fresco and similar cheeses generally falls within this optimal pH range for growth of L. monocytogenes.

For years, Listeria monocytogenes has been a source of health problems in the United States. Listeria outbreaks continue to be a serious concern, and significant resources have been put toward reducing the number of Listeria-related illnesses and deaths. As a result of an initiative enacted during the Clinton administration, the USDA has developed regulations intended to lower future incidences. However, the U.S. Center for Disease Control and Prevention has noted that the rate of Listeria food poisoning rose in 2005 to 3 cases per million people (an increase from 2.7 cases per million in 2004), and that the United States fell short of its 2005 goal to reduce cases of foodborne Listeria by 50 percent.

Staphylococcus aureus has also proven to be a problematic pathogen linked to soft cheeses. Food poisoning caused by S. aureus has been more of a problem in other countries, however, where fresh cheeses can be produced from raw milk. Likewise, Clostridium botulinum (botulism) and Escherichia coli have been a major problem in a number of food products, including fresh cheeses. In June of 1998, the Wisconsin Department of Health and Family Services implicated fresh (held less than 60 days) cheese curds from a dairy plant as the source of E. coli infection in several individuals.

Not only is pathogen contamination of the cheeses harmful to consumers and detrimental to the reputation of the cheese manufacturer, but ensuing product recalls are extremely expensive and detrimental to the market for the cheese. The control of pathogen growth, including Listeria monocytogenes growth, on fresh cheeses is therefore important to cheese producers, and the general public, both in terms of safety and economics.

One traditional method of increasing microbial resistance of foods is to increase the acidity (decrease the pH) of a food composition. However, this method alone yields an unsatisfactory result in many fresh cheeses. Acidification of Queso Fresco reduces melt restriction (i.e., allows the cheese to melt rather than just soften). Many common edible acids, such as vinegar, lactic acid, citric acid, and the like, additionally impart an undesired sour flavor to the cheese. These changes destroy the identity of fresh cheeses by significantly altering their distinctive organoleptic and functional properties.

A variety of methods have been developed in order to reduce the incidence of cheese contamination. Bacteriocins are proteinaceous compounds naturally produced by bacteria to inhibit growth of similar or closely related bacterial strains. For example, some strains of Streptococcus lactis may be used to produce nisin, an antimicrobial substance with known food preservative properties. Nisin generally inhibits the growth of certain Gram-positive bacteria, such as Listeria monocytogenes, but is not effective against Gram-negative bacteria, yeasts, or molds. Nisin also has the ability to inhibit certain aerobic and anaerobic spore-forming organisms. There are many bacteriocins, with a wide variety of functions, many of which may be used to prevent or reduce microbial growth in dairy products.

### SUMMARY OF THE INVENTION

The present invention provides a new, highly antimicrobial dairy product that is resistant to growth of both Gram positive and Gram negative food-borne pathogens. Remarkably, cheeses manufactured according to aspects of the present invention are resistant to all five major pathogens that commonly present contamination problems in cheese. The present invention includes acidifying a dairy product to a pH of 4.5 to 6.1 with one or more inorganic acidulants and then incorporating an antimicrobial composition containing one or more bacteriocins and one or more antimicrobial organic acids. Bacteriocins suitable for use in the antimicrobial composition of the present invention include, but are not limited to, nisin, pediocin, sakacin, reuterin, colicin, enterocin, leucocin, lacticin, lactocin, lactacin, lactococcin, lactostrepcin, diplococcin, macedocin, or helveticin and their respective culture preparations. Antimicrobial organic acids suitable for use in the antimicrobial composition of the present invention include, but are not limited to, sorbic acid, benzoic acid, propionic acid, acetic acid, diacetic acid, and their respective metal salts.

The present invention provides dairy compositions with improved microbial stability against common food-borne pathogenic bacteria including Clostridium botulinum, Listeria monocytogenes, Staphylococcus aureus, Escherichia coli and Salmonella under refrigerated storage. The antimicrobial compositions of the present invention function optimally at lowered pH levels, so that the combination of inorganic acids, bacteriocins, and organic acids used creates a synergy that yields excellent antimicrobial results. Furthermore, the present invention also describes a means to make non-sour, melt-restricted dairy products (e.g., cheese (such as Queso Fresco), dairy spreads, dairy snacks, dairy desserts, and dairy dips) with improved microbial stability at the targeted/reduced pH by cross-linking the whey protein through controlled heating.

### DETAILED DESCRIPTION

The present invention relates to methods of manufacturing fresh dairy and/or cheese compositions that are resistant to microbial growth. Such dairy and/or cheese compositions may be stored for extended periods of time (about 4 weeks or more) under refrigerated storage conditions with significantly reduced risk of bacterial growth in the case of contamination. More specifically, the present invention is useful for manufacturing natural fresh cheese (cheese made without final pasteurization) that has relatively high moisture content (water activity greater than about 0.85), low meltability, and high resistance to growth of pathogenic bacteria including Clostridium botulinum, Listeria monocytogenes, Staphylococcus aureus, Escherichia coli, and Salmonella under refrigerated conditions for time periods of at least about 4 weeks. For purposes of this invention, “significantly reduced risk of bacterial growth” is intended to be relative to a similar but conventionally prepared cheese; such “significantly reduced risk of bacterial growth” is sufficient to provide high resistance to growth of such pathogenic bacteria upon storage under refrigerated conditions for at least about 4 weeks.

Cheeses and cheese compositions made according to methods of the present invention have a non-sour flavor and a level of melt-restriction desired in such cheeses, despite the addition of acid which would normally alter the flavor and functional properties of the cheese or cheese composition. For instance, Queso Fresco made according to methods of the present invention has a mild flavor and high melt-restriction, as with normal Queso Fresco, but also has increased microbial stability and an enhanced refrigerated shelf life.

In one aspect, the present invention comprises a method of manufacturing a cheese composition that is resistant to microbial growth wherein a cheese composition is manufactured according to normal practices, except that during processing an inorganic acidic composition is added to the cheese composition to create an acidified fresh cheese that has a pH of about 4.5 to about 6.1, preferably about 5.3 to about 5.7, and thereafter an acidic antimicrobial composition is mixed with the cheese composition prior to cooling.

The inorganic acidic composition is selected to avoid imparting sour flavors to the cheese, a common effect from acidifying cheese compositions. The inorganic acidic composition is a food grade acidulant including inorganic acids, the metal salts of inorganic acid, or mixtures thereof. Examples include, but are not limited to, hydrochloric acid, sulfuric acid, phosphoric acid, sodium bisulfate, potassium bisulfate, acidic calcium sulfate, monosodium phosphate, monopotassium phosphate, acidic calcium phosphate, sodium acid pyrophosphate, potassium acid pyrophosphate, and the like. By using an inorganic acid, its salt, or combinations thereof, the invention avoids producing a sour cheese composition as an end result. The inorganic acidic composition is added to milk before the milk is made into cheese. The addition of the inorganic acidic composition lowers the pH of the cheese composition to which it is added by at least 0.5 pH units, preferably at least about 1.0 pH unit.

If an especially low pH is required, such as a pH of about 4.5 to about 5.3, in order to provide maximum microbial resistance, a two-stage acidification process could be used, wherein an acid composition comprising a first inorganic acid and/or an inorganic acid salt is added to cold pasteurized milk to provide a pH of about 5.3 to about 5.35, followed by a second stage of acidification wherein a second acidic composition comprising an inorganic acid and/or an inorganic acid salt is added so that the dairy composition achieves its target pH. In such two-stage acidification methods, the first and second acidic compositions may be the same or different.

The antimicrobial composition that is then mixed with the dairy composition comprises at least one bacteriocin and at least one antimicrobial organic acid. A wide range of bacteriocins exist with a variety of functions and modes of growth inhibition. The bacteriocins used in the antimicrobial composition of the present invention should be selected to inhibit the growth of G(+) and/or G(−) food-borne pathogens. The bacteriocin may be, without limitation, nisin, pediocin, sakacin, reuterin, colicin, enterocin, leucocin, lacticin, lactocin, lactacin, lactococcin, lactostrepcin, diplococcin, macedocin, or helveticin and their respective culture preparations. Preferably, the bacteriocin is added as a purified component rather than as a culture to minimize the effect on flavor and other organoleptic properties. The antimicrobial organic acid should be selected to inhibit or arrest the growth of yeasts and molds, and potentially pathogens. The organic acid may be, without limitation, sorbic acid, benzoic acid, propionic acid, acetic acid, diacetic acid, and their respective metal salts. In addition to the bacteriocin and antimicrobial organic acid, natural and artificial preservatives may optionally be added to the antimicrobial composition. Preferably, the final dairy product contains about 0.0002 to about 0.2 percent of the bacteriocin compound and about 0.001 to about 0.2 percent of the antimicrobial organic acid.

In a further aspect of the invention, desirable functional properties such as melt-restriction may be preserved, despite acidification, by effecting cross-linking of whey proteins through controlled heating of the cheese composition. This aspect of the invention makes it possible to produce fresh natural cheeses and fresh cheese compositions with enhanced microbial stability. Normally, adding acidic compositions to fresh cheese will detract from its flavor characteristics and functional properties. Fresh cheese characteristically has a high pH, a mild flavor, and high melt restriction, causing it to soften but not melt upon heating. Lowering the pH of fresh cheese, while enhancing shelf life, traditionally gives the cheese an undesirable sour flavor uncharacteristic of that type of cheese. Moreover, protein degradation caused by the acid lowers the melt-restriction of the cheese, leading to undesirable melting under higher temperatures. Through controlled heating according to the present invention, fresh natural cheeses and fresh cheese compositions may be produced that have normal flavors and high melt restriction.

In order to enhance melt restriction of an acidified fresh cheese, controlled heating can be used to effect cross-linking of whey protein in the cheese. Cross-linking of whey protein is achieved by heating milk at a high temperature, generally about 160° F. to about 210° F., and more preferably about 170° F. to about 190° F., for a time of about 15 seconds to about 30 minutes, preferably about 30 seconds to about 10 minutes. The degree of whey protein cross-linking is affected by both temperature and duration of heat treatment. The heat treatment may be used to control the degree of whey protein cross-linking, and, therefore, the degree of melt restriction in the final product. To achieve suitable melt-restriction properties, proper heat treatment of initial dairy ingredient should be conducted to achieve at least 20 percent, and preferably at least about 40 percent, cross-linking of whey protein.

The heat-treated milk may then be acidified as described above using an inorganic acid or inorganic acid salt in order to lower the pH of milk, thereby reducing the pH of the cheese that is eventually produced from the acidified milk. Enzymes, such as rennet, chymosin, and the like, may then be added to the heat-treated milk in order to form curds or protein gels. An antimicrobial composition, comprising at least one bacteriocin and at least one edible organic acid, may be added to the drained curds or protein gel in order to inhibit microbial growth.

The antimicrobial properties of the resulting dairy product are enhanced by the synergy between the antimicrobial composition and the reduced pH caused by acidification of the milk used to make the dairy product.

The present invention is especially useful in the preparation of fresh cheeses normally having high pH and which are highly susceptible to the growth of pathogens. Preparation of Queso Fresco with antimicrobial properties is an especially preferred embodiment of the present invention. The manufacture of fresh cheese incorporating the present invention begins with pasteurized milk. Rather than beginning the manufacture with HTST (high temperature, short time) pasteurized milk, as in the manufacture of most cheeses, the milk may be heat-treated at high temperatures (e.g., about 170° F. to about 190° F. for about 15 seconds to about 5 minutes), to achieve at least about 20 percent, and preferably at least about 40 percent, whey protein cross-linking if a melt-restricted cheese is desired. By heating at higher temperatures for a longer period of time, increased cross-linking of whey proteins will be achieved, which will enhance the melt restriction of the final cheese.

The milk is then acidified by using one or more inorganic acidulants, the salts of one or more inorganic acids, or a combination thereof. Use of inorganic acids at this stage rather than organic acids (which are more traditionally used in cheese-making) helps to avoid creation of a finished cheese having modified flavors, such as the sour flavor associated with most high-acidity cheeses. Inorganic acid is added to the milk until it reaches a target pH, preferably about 4.6 to about 6.1, and more preferably a pH of about 5.3 to about 5.5. The milk may optionally be combined with coagulation aids (such as a CaCl₂ solution) prior to acidification in order to increase curd strength or yield. Following the addition of acid, the acidified milk may then be heated (preferably to about 70° F. to about 110° F. and more preferably to about 90° F.). A coagulation enzyme is then added to form curds from the acidified milk. Examples of coagulation enzymes commonly used include natural rennet and microbially-produced chymosin (for example, Chymax®, distributed by Chr. Hansen's, Inc., Milwaukee, Wis.); however any enzyme effective for coagulating the milk and producing curds may be used. Optionally, a starter culture can also be added to provide specific flavors or other attributes.

The mixture may then be incubated to allow the curds to set (preferably at about 70° F. to about 110° F. for about 15 to about 75 minutes, more preferably about 90° F. for about 40 to about 45 minutes). The curds may be cut into relatively small pieces and then allowed to heal for 5 to 10 minutes. After healing, the curds generally are heated to about 110° F. with slow agitation and maintained at about 110° F. for about 45 minutes. If a firmer texture (especially for melt-restricted cheese) is desired, heating can be accomplished at a higher temperature than otherwise used to make fresh cheese (for example, the pieces of curd may be heated at about 140° F. for about 45 minutes). The heated composition is then allowed to stand at ambient temperature in order to settle the curds. The curds are then separated from the whey and comminuted. The inventive microbiological composition is then added to the comminuted curds. Optionally, flavoring ingredients (e.g., salt, sweeteners, spices, and the like) can also be added to the comminuted curds. The comminuted curds are then placed in a mold and pressed to form a finished fresh cheese.

The initial heat treatment of milk, using higher temperatures for a longer time than in traditional milk pasteurization, promotes cross-linking of whey proteins. Although not wishing to be limited by theory, it is believed that this cross-linking of whey proteins is the main mechanism through which melt restriction of the final product is achieved. The degree of melt restriction is directly related to the temperature and duration of the heat treatment and, therefore, whey protein cross-linking. The cooking of curds at a higher temperature in order to provide firmer curds allows the finished cheese to attain traditional textural attributes associated with such fresh cheeses (i.e., chewiness and/or crumbliness). By combining these techniques with the novel acid and antimicrobial treatments of the present invention, a fresh cheese such as Queso Fresco may be produced that has flavor and functional properties similar to those of normal fresh cheeses, but that advantageously has enhanced microbial resistance when compared to typical fresh cheeses produced with HTST pasteurized milk using conventional techniques.

Although the invention is described herein mainly with respect to fresh cheese, specifically Queso Fresco, the disclosure is not meant to be limiting. It will be recognized that the present invention may be used to enhance microbiological stability of a wide variety of dairy products, including but not limited to cheese, dairy spreads, dairy snacks, dairy desserts, and dairy dips.

### COMPARATIVE EXAMPLE 1

A control sample of a typical untreated Queso Fresco cheese was prepared for comparison to cheeses of the present invention. Bacterial growth of both types of cheese was monitored at refrigerated temperature (45° F.) and at a slightly abusive temperature (55° F.). The control sample was a commercially produced Queso Fresco cheese. The control samples were inoculated with the following psychrotrophic pathogens at an initial level of about 100 cfu/g: Listeria monocytogenes, Escherichia coli O157:H7, Salmonella species, Staphylococcus aureus and Clostridium botulinum. The control samples were then vacuum sealed and stored for up to two weeks. Half of the samples were stored at refrigerated temperature (45° F.), while the other half were stored at the higher temperature (55° F.). The control samples were tested for pathogen growth at set intervals. At refrigerated temperature, L. monocytogenes achieved 1 log of growth in 5 days, while E. coli achieved more than 1 log of growth in 7 days. At the slightly abusive temperature of 55° F., L. monocytogenes, Salmonella and E. coli all achieved significant growth (at least 1 log) within 7 days. These results suggest that normal fresh Queso Fresco is very susceptible to the growth of many pathogens, especially L. monocytogenes and E. coli, even at the refrigerated temperature.

A second comparative Queso Fresco containing an antimicrobial composition according to the present invention but having a standard pH was produced using a non-commercial-scale process. The manufacture of this Queso Fresco began with 30 pounds of HTST (high temperature short time pasteurized) milk (165° F. for 16 seconds) that was cooled and placed in a miniature cheese vat. The pH of this non-acidified milk was about 6.8. The milk was combined with a solution of 0.02% CalSol (45% CaCl2 solution; Chr. Hansen, Milwaukee, Wis.) and then heated to about 90° F. 71.46 g of a 1% Chymax enzyme solution (Chr. Hansen, Milwaukee, Wis.) was then added to the vat, and the entire composition was incubated at about 90° F. for about 40 to 45 minutes until the curd set. The curds were then cut into cubes with sides approximately ¼ inch. The curds were then allowed to heal for 5 to 10 minutes. After healing, the curds and whey were heated to about 110° F. with slow agitation and maintained at 110° F. for 45 minutes. The composition was then allowed to stand for 5 minutes in order to settle the curds. The composition was then poured through a cheesecloth, and free whey was squeezed out by hand. The curds were then ground in a food processor with 2.5% salt and a preservative cocktail consisting of 0.05 wt % potassium sorbate, 0.05 wt % Nisaplin™, and 0.5 wt % NovaGard™ CB1 (blend containing cultured dextrose, sodium diacetate, egg white lysozyme, nisin, and maltodextrin). All percentages were determined on a basis of curd weight. Both NovaGard™ CB1 and Nisaplin™ were supplied by Danisco A/S.

Ground curds were placed in a mold and pressed for about one hour. After pressing, the curds were released from the mold, wrapped in Saran® wrap, placed in plastic bags, and stored at refrigeration temperature (about 45° F.). The resulting Queso Fresco cheese had the characteristic mild flavor of Queso Fresco, with a pH of 6.2 and good melt restriction.

Both the second comparative cheese sample and the commercially-produced control sample were inoculated with L. monocytogenes and E. coli at initial levels of about 100 cfu/g. The L. monocytogenes used in this example was a mixture of 6-strains isolated from dairy and meat outbreaks, as well as strains found in the food processing environment. The E. Coli used in this example was a generic species obtained from American Type Culture Collection with the strain designation of ATCC 51739. The inoculated samples were stored at about 45° F. for a period of 12 weeks. During refrigerated storage, samples were taken for enumeration of Listeria monocytogenes on a MOX (modified Oxford Medium) supplemented with a Listeria-selective additive. Samples were enumerated for E. coli on a VRB (violet red bile) medium.

Although there was no significant growth of E. coli in the second comparative sample, the growth of L. monocytogenes became unacceptable after 3 weeks in the comparative sample. Although these results show an improvement over the control sample in terms of microbial resistance, they also demonstrate that adding the antimicrobial composition of the invention alone, without lowering the pH of the cheese, was insufficient to control pathogen growth.

### EXAMPLE 2

This Example involves an inventive Queso Fresco that contained an antimicrobial composition and also had a reduced pH to magnify the antimicrobial effects of the treatment. The second inventive sample was produced using a process similar to the process that yielded the comparative cheese of the first example. The manufacture of this inventive Queso Fresco began with 30 pounds of HTST pasteurized milk (165° F. for 16 seconds). The milk, which had a pH of about 6.8, was cooled and placed in a miniature cheese vat. The milk was combined with a solution of 0.02% CalSol (45% CaCl₂ solution; Chr. Hansen, Milwaukee, Wis.) and then combined with 180 g of 2.5N HCl, so that the cold acidified milk reached a pH of 5.3 to 5.35. Following the addition of acid, the acidified milk was heated to about 90° F. 35.73 g of a 1% Chymax solution (Chr. Hansen, Milwaukee, Wis.); half the amount used in the previous example) was then added to the vat, and the entire composition was incubated at about 90° F. for about 40 to 45 minutes until the curd set. The curds were then cut into cubes with sides approximately ¼ inch. The curds were then allowed to heal for 5 to 10 minutes. After healing, the curds and whey were heated to about 110° F. with slow agitation and maintain at 110° F. for 45 minutes. The composition was then allowed to stand for 5 minutes in order to settle the curds and then poured through a cheesecloth, and free whey was squeezed out by hand. The curds were then ground in a food processor with 2.5% salt and a preservative cocktail consisting of 0.05 wt % potassium sorbate, 0.05 wt % Nisaplin, and 0.5 wt % NovaGard CB1. All percentages were determined on a basis of curd weight. Ground curds were placed in a mold and pressed for about one hour. After pressing, the curds were released from the mold, wrapped in Saran® wrap, placed in a plastic bag, and stored at refrigeration temperature (about 45° F.).

The resulting Queso Fresco cheese had a pH of 5.5, and had a soft texture, but was not melt restricted. The sample was then inoculated with L. monocytogenes and E. coli at an initial level of about 100 cfu/g and stored at about 45° F. for a period of 12 weeks. It passed the 12-week microbial challenge studies for L. monocytogenes and E. coli. Although this sample cheese is resistant to growth of pathogens and may be useful in some applications, it does not have functional properties that match normal Queso Fresco.

### EXAMPLE 3

The third example involves an inventive melt restricted Queso Fresco that contained an antimicrobial composition and also had a reduced pH to magnify the antimicrobial effects of the treatment. This inventive sample was produced using a process similar to that described in Example 2, but incorporated a more severe heat treatment in order to enhance melt restriction. Rather than beginning the cheese-making process with HTST pasteurized milk (as used in previous examples), this inventive process began with milk that was heat-treated at 170 to 190° F. for 5 to 10 minutes to achieve increased levels of cross-linking of the whey protein; cross-linking was estimated at greater than about 50 percent. The milk was then cooled and placed in a miniature cheese vat. The milk was combined with a solution of 0.02% CalSol (45% CaCl₂ solution; Chr. Hansen, Milwaukee, Wis.) and then combined with 180 g of 2.5N HCl, so that the cold acidified milk reached a pH of 5.3 to 5.35. Following the addition of acid, the acidified milk was heated to about 90° F. 35.73 g of a 1% Chymax solution (Chr. Hansen, Milwaukee, Wis.) was then added to the vat, and the entire composition was incubated at about 90° F. for about 40 to 45 minutes until the curd set. The curds were then cut into cubes with sides approximately ¼ inch. The curds were then allowed to heal for 5 to 10 minutes. After healing, the curds and whey were heated to about 140° F. (rather than 110° F. as in previous examples) with slow agitation and maintained at 140° F. for 45 minutes. The composition was then allowed to stand for 5 minutes in order to settle the curds. The composition was then poured through a cheesecloth, and free whey was squeezed out by hand.

The curds were then ground in a food processor with 2.5% salt and an anti-microbial composition was added in an amount sufficient to provide 0.05 wt % potassium sorbate, 0.05 wt % Nisaplin™, and 0.5 wt % NovaGard™ CB1. All percentages were determined on a basis of curd weight.

The ground curds were then placed in a mold and pressed for about one hour. After pressing, the curds were released from the mold, wrapped in Saran®, placed in a plastic bag, and stored at refrigeration temperature (about 45° F.).

This sample differed from the Example 2 inventive sample in two respects. First, the milk was initially treated at a higher temperature for a longer period of time (170-190° F. for 5-10 minutes rather than a HTST process of 165° F. for 16 seconds). This initial heating promotes cross-linking of whey proteins, which will enhance melt restriction in the final product. The degree of melt restriction is directly related to the amount of heat treatment and whey protein cross-linking. Generally, a higher degree of heat treatment will generate more whey protein cross-linking in milk, and, therefore, more melt-restriction for finished products. The second major distinction between this example and previous examples is that the curds and whey are cooked at a higher temperature (140° F. rather than 110° F.) in order to provide firmer curds. These modifications produced a Queso Fresco with flavor and functional properties similar to those in the control and example, but with enhanced microbial resistance similar to Example 2. It was identified that at pH of about 5.5, the acidified Queso Fresco will need at least about 20% of whey protein cross-linking to provide proper melt restriction properties similar to the traditional Queso Fresco.

In addition to normal functional and organoleptic properties, this inventive sample showed increased resistance to microbiological growth. This inventive sample was inoculated with L. monocytogenes and E. Coli, the two pathogenic organisms that exhibited the most growth in the control samples. There was no detectable growth of L. monocytogenes and E. coli in this inventive Queso Fresco sample over a period 12 weeks when stored at refrigerated temperatures (about 45° F.), in contrast to the control sample where growth of both organisms exceeded 1 log within only one week. Tests were only conducted over a 12 week period; thus, microbiological stability for even greater periods may be possible.

### EXAMPLE 4

Another inventive sample was prepared using the same method as described above in Example 3, except that the antimicrobial composition added contained only 0.05% potassium sorbate and 0.07% Nisaplin by weight (based on the weight of curds before grinding). NovaGard™ CB1 was not used in the antimicrobial composition. No detectable growth of L. monocytogenes and E. coli was present in this inventive sample over an 8 week test period when stored under refrigeration conditions.

### EXAMPLE 5

A sweetened milk gel was produced that had enhanced microbial resistance. A solution comprising 90% ultrafiltered milk (concentrated to about 4.4 times the initial concentration), 8% sugar, 0.05% CalSol, 0.05% Potassium Sorbate, 0.05% Nisaplin, 0.5% NovaGard CB1, and 0.66% of 2.5N HCl was placed in a container and mixed with 0.2 to 0.4% of 0.02% Chymax solution (all percentages indicated by weight). The resulting mixture was incubated at 90° F. for 40 minutes, and then stored under refrigeration conditions (about 45° F.). This produced a sweetened milk gel with enhanced microbial stability.

The melt restriction properties of milk gel depend on the amount of heat treatment and therefore, the degree of whey protein cross-linking. If the ultrafiltered milk was treated at 185° F. for 1 minute before addition of the other ingredients, it can produce melt-restricted and smooth sweetened milk gel with a pH of about 5.5 and improved microbial stability compared to similar milk gel snacks produced without an antimicrobial composition prepared according to the present invention. Snacks made with HTST pasteurized milk but without such additional heat treatment did not exhibit similar melt restriction or smooth texture.

What is claimed is:

1. A method of manufacturing a dairy product composition that is resistant to microbial growth, the method comprising:
providing a dairy product;
adding an inorganic acidulant to the dairy product to create an acidified dairy product that has a pH of about 4.5 to about 6.1; and
adding a bacteriocin compound and an antimicrobial organic acid to the acidified dairy product in amounts effective to provide resistance to microbial growth for at least about 4 weeks under refrigeration conditions for the dairy product composition.

2. The method of claim 1, wherein the dairy product composition is a fresh cheese.

3. The method of claim 1, wherein the inorganic acidulant is hydrochloric acid, sulfuric acid, phosphoric acid, sodium bisulfate, potassium bisulfate, acidic calcium sulfate, monosodium phosphate, monopotassium phosphate, acidic calcium phosphate, sodium acid pyrophosphate, potassium acid pyrophosphate, or mixtures thereof; wherein the bacteriocin compound comprises nisin, pediocin, sakacin, reuterin, colicin, enterocin, leucocin, lacticin, lactocin, lactacin, lactococcin, lactostrepcin, diplococcin, macedocin, helveticin, or mixtures thereof; and wherein the antimicrobial organic acid comprises sorbic acid, benzoic acid, propionic acid, acetic acid, diacetic acid, a salt thereof, or a mixture thereof.

4. The method of claim 2, wherein the inorganic acidulant is hydrochloric acid, sulfuric acid, phosphoric acid, sodium bisulfate, potassium bisulfate, acidic calcium sulfate, monosodium phosphate, monopotassium phosphate, acidic calcium phosphate, sodium acid pyrophosphate, potassium acid pyrophosphate, or mixtures thereof; wherein the bacteriocin compound comprises nisin, pediocin, sakacin, reuterin, colicin, enterocin, leucocin, lacticin, lactocin, lactacin, lactococcin, lactostrepcin, diplococcin, macedocin, helveticin, or mixtures thereof; and wherein the antimicrobial organic acid comprises sorbic acid, benzoic acid, propionic acid, acetic acid, diacetic acid, a salt thereof, or mixtures thereof.

5. The method of claim 3, wherein the dairy product composition contains about 0.0002 to about 0.2 percent of the bacteriocin compound and about 0.001 to about 0.2 percent of the antimicrobial organic acid by weight.

6. The method of claim 4, wherein the dairy product composition contains about 0.0002 to about 0.2 percent of the bacteriocin compound and about 0.001 to about 0.2 percent of the antimicrobial organic acid by weight.

7. The method of claim 2, wherein the fresh cheese is Queso Fresco.

8. The method of claim 4, wherein the fresh cheese is Queso Fresco.

9. The method of claim 6, wherein the fresh cheese is Queso Fresco.

10. A method of manufacturing a dairy composition that is resistant to microbial growth, the method comprising:
combining milk and at least one inorganic acidiulant to provide an acidified milk;
adding an enzyme to the acidified milk to create curds;
incubating the curds;
comminuting the curds to create comminuted curds;
adding an antimicrobial composition to the comminuted curds; and
pressing the comminuted curds to form a finished cheese.

11. The method of claim 10, wherein the antimicrobial composition comprises a bacteriocin compound and an antimicrobial organic acid.

12. The method of claim 10, wherein the bacteriocin compound comprises nisin, pediocin, sakacin, reuterin, colicin, enterocin, leucocin, lacticin, lactocin, lactacin, lactococcin, lactostrepcin, diplococcin, macedocin, helveticin, or mixtures thereof, and wherein the antimicrobial organic acid comprises sorbic acid, benzoic acid, propionic acid, acetic acid, diacetic acid, a salt thereof, or mixtures thereof.

13. The method of claim 11, wherein the bacteriocin compound comprises nisin, pediocin, sakacin, reuterin, colicin, enterocin, leucocin, lacticin, lactocin, lactacin, lactococcin, lactostrepcin, diplococcin, macedocin, helveticin, or mixtures thereof, and wherein the antimicrobial organic acid comprises sorbic acid, benzoic acid, propionic acid, acetic acid, diacetic acid, a salt thereof, or mixtures thereof.

14. The method of claim 12, wherein the milk, either before or after acidification, but before the addition of the enzyme, is heat treated to achieve at least about 20 percent cross-linking of whey proteins in the milk.

15. The method of claim 13, wherein the milk, either before or after acidification, but before the addition of the enzyme, is heat treated to achieve at least about 20 percent cross-linking of whey proteins in the milk.

16. A method of manufacturing a fresh cheese product that is resistant to microbial growth, the method comprising:
(1) combining milk with an inorganic acid compound to provide an acidified milk that has a pH of about 4.5 to about 6.1;
(2) adding an enzyme to the acidified milk;
(3) incubating the enzyme-containing milk at a temperature of about 70 to about 110° F. for about 15 to about 75 minutes to form a gel;
(4) cutting the gel to form a curds and whey mixture;
(5) heating the curds and whey mixture 70 to about 160° F. for about 15 to about 75 minutes to firm the curds;
(6) draining the curds
(7) adding a bacteriocin compound and an antimicrobial organic acid to the drained curds in amounts effective to resist microbial growth; and
(8) pressing the curds from step (7) to form the fresh cheese product.

17. The method of claim 16, wherein the bacteriocin compound comprises nisin, pediocin, sakacin, reuterin, colicin, enterocin, leucocin, lacticin, lactocin, lactacin, lactococcin, lactostrepcin, diplococcin, macedocin, helveticin, or mixtures thereof, and wherein the antimicrobial organic acid comprises sorbic acid, benzoic acid, propionic acid, acetic acid, diacetic acid, a salt thereof, or mixtures thereof.

18. The method of claim 17, wherein either the milk used in step (1) or the acidified milk prepared in step (1) is heated to a temperature and for a time sufficient to cross-link at least 20 percent of whey protein contained therein, prior to step (2).

19. The method of claim 17, wherein the fresh cheese product is Queso Fresco.

20. The method of claim 18, wherein the fresh cheese product is Queso Fresco.
